(19) United States
(12) Patent Application Publication
(10) Pub. No.: US 2002/0124056 A1
(43) Pub. Date: Sep. 5, 2002

(54) Method and apparatus for modifying a web page

(75) Inventors: Rabindranath Dutta, Austin, TX (US); Karthikeyan Ramamoorthy, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/797,813

(22) Filed: Mar. 1, 2001

(51) Int. Cl. G06F 15/16

(52) U.S. Cl. 709/218; 709/219

(57) ABSTRACT

A method, apparatus, and computer implemented instructions for processing a request for a Web page in a data processing system. In response to receiving a request from client data processing system for the Web page, the Web page is retrieved from a Web server. An analysis of the Web page is initiated. The analysis generates a list of key words from the Web page. The Web page and the list of key words are sent to the client data processing system.

### BACKGROUND OF THE INVENTION

1. Technical Field

The present invention generally relates generally to an improved data processing system, and in particular to a method and apparatus for presenting data. Still more particularly, the present invention provides a method and apparatus for presenting data to a visually impaired user.

2. Description of Related Art

The Internet, also referred to as an “internetwork”, is a set of computer networks, possibly dissimilar, joined together by means of gateways that handle data transfer and the conversion of messages from the sending network to the protocols used by the receiving network (with packets if necessary). When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies, which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

Vision impaired users of the Web often rely on tools, such as a talking Web browser. An example of a talking Web browser is the Home Page Reader (HPR), which is available from International Business Machines Corporation (IBM). HPR is a spoken on-ramp to the Information Highway for computer users who are blind or visually impaired. HPR provides Web access by quickly, easily, and efficiently speaking Web page information. HPR provides a simple, easy-to-use interface for navigating and manipulating Web page elements. Using the keyboard to navigate, a user who is blind or who has a visual impairment can hear the full range of Web page content provided in a logical, clear, and understandable manner.

In perceptual psychology, a notion of gestaltic comprehension is present in which the perception is manifested by understanding the whole rather than analyzing small parts and combining them. For example, when a user views a Web page, a quick glance is all that it takes for the user to decide whether to read the Web page. Often the quick glance is focused on the icons and/or pictures and some heavily enlarged or bolded headlines in the Web page. Unfortunately, with users who are blind, the gestaltic perception of the Web page is more difficult. Part of this difficulty occurs because speech is more sequential than vision.

The present invention recognizes that one problem with talking browsers is that an overview of the page is unavailable because this type of Web browser moves from topic to topic in a sequential manner. These presently available talking web browsers read one hyper-link and move from topic to topic. Presently, no easy mechanism or structure is present for obtaining an overview of the Web page with a quick scan, which is possible by users who do not have a visual impairment. No requirements are present as to Web page design as with other types of documents, such as books, newspaper articles, or scientific papers. These documents usually conform to certain conventions, such as, for example, including an abstract, a conclusion, a preface, or an index.

Therefore, it would be advantageous to have an improved method, apparatus and computer implemented instructions for presenting a Web page to a user who may be visually impaired.

### SUMMARY OF THE INVENTION

The present invention provides a method, apparatus, and computer implemented instructions for processing a request for a Web page in a data processing system. In response to receiving a request from client data processing system for the Web page, the Web page is retrieved from a Web server. An analysis of the Web page is initiated. The analysis generates a list of key words from the Web page. The Web page and the list of key words are sent to the client data processing system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating data flow in modifying a Web page to include key words in accordance with a preferred embodiment of the present invention;

FIG. 5 is a flowchart of a process used for handling a request for a Web page from a user at a browser in accordance with a preferred embodiment of the present invention; and

FIG. 6 is a flowchart of a process used for generating a key word list in accordance with a preferred embodiment of the present invention.

### DETAILED DESCRIPTION OF THE PREFERRED EMBODIMENT

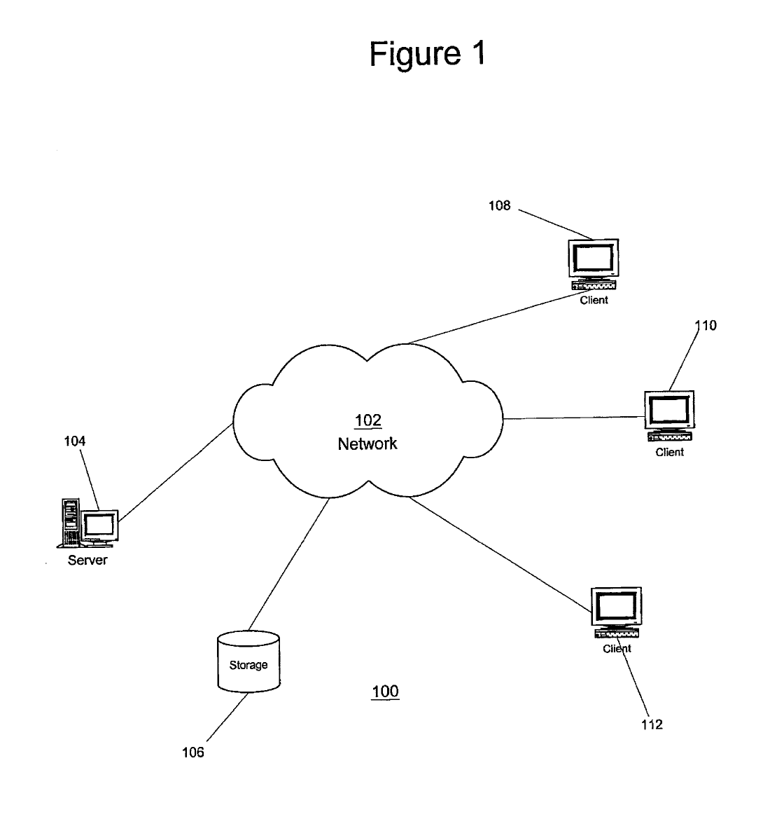

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

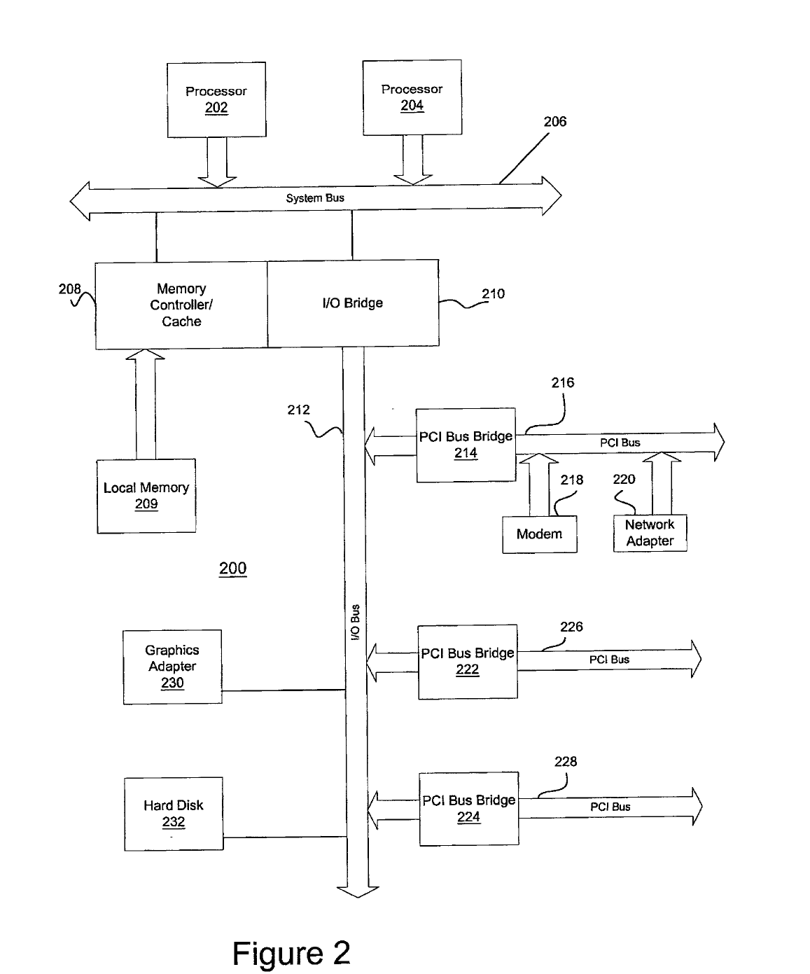

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

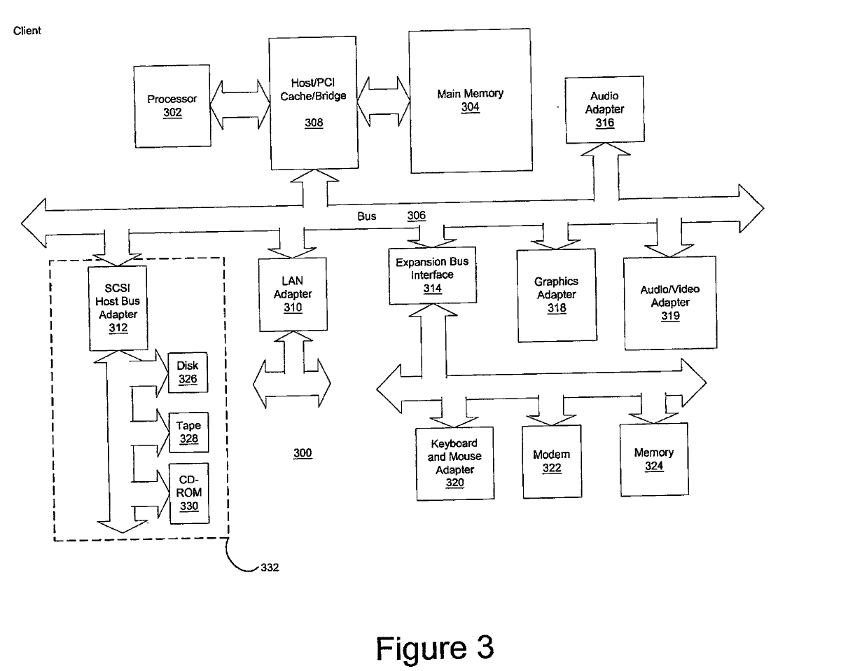

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

Typically, users provide one or more key words and a search engine returns one or more Web pages based on the relevancy of the key words within the Web pages. The present invention provides a method, apparatus, and computer implemented instructions for using a modified search engine server to analyze a Web page for its content and to provide a list of key words based on this analysis. The Web page is modified to include the key words at the top of the Web page. The talking Web browser or other program, such as the Home Page Reader (HPR) present the list of key words in an audible manner prior to presenting other portions of the Web page.

HPR is a spoken on-ramp to the Information Highway for computer users who are blind or visually impaired. HPR provides Web access by quickly, easily, and efficiently speaking Web page information. HPR provides a simple, easy-to-use interface for navigating and manipulating Web page elements. Using the keyboard to navigate, a user who is blind or who has a visual impairment can hear the full range of Web page content provided in a logical, clear, and understandable manner.

This list of key words provides a quick clue or summary of contents of a Web page.

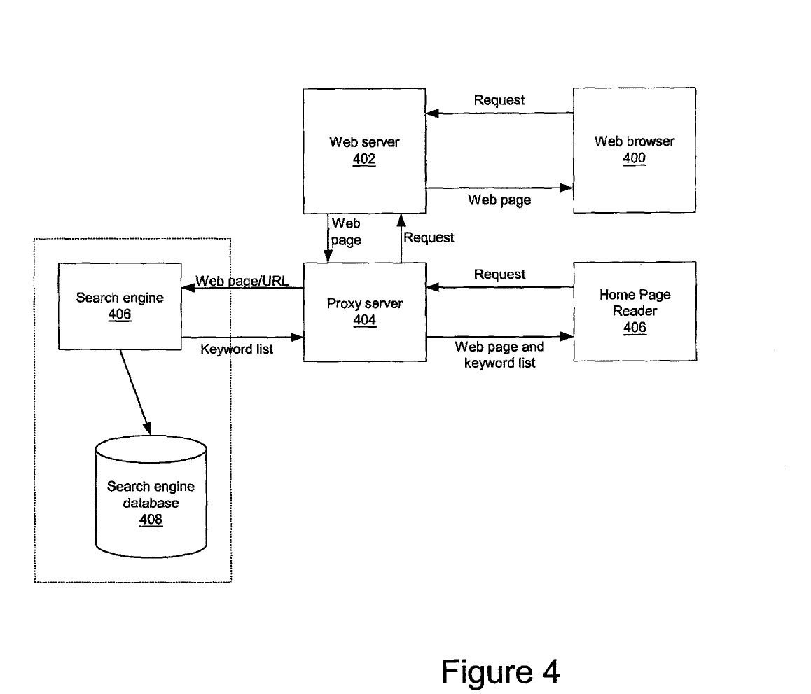

Turning next to FIG. 4, a diagram illustrating data flow in modifying a Web page to include key words is depicted in accordance with a preferred embodiment of the present invention. The data flow illustrated in FIG. 4 depicts a process used to perform a reverse lookup of key words and a modification of a Web page to include the key words at the top of the Web page to allow talking Web browsers to present a content index of the Web page.

In the depicted examples, users without visual impairment typically specify a universal resource locater (URL) using Web browser 400. This URL is sent as a request to Web server 402, which returns a Web page to Web browser 400. Web server 402 may be located on a server, such as data processing system 200 in FIG. 2, while Web browser 400 may be located on a client, such as data processing system 300 in FIG. 3.

The mechanism of the present invention adds or employs proxy server 404 in which Home Page Reader 406 sends a request containing the URL to proxy server 404. A proxy server is also referred to as a “proxy” or “application level gateway”. The proxy server is an application that breaks the connection between sender and receiver. All input is forwarded out a different port, closing a straight path between two networks and preventing a hacker from obtaining internal addresses and details of a private network. Proxy servers are available for common Internet services. For example, an HTTP proxy is used for Web access, and an SMTP proxy is used for e-mail. Proxy servers generally employ network address translation (NAT), which presents one organization-wide IP address to the Internet. Proxy servers funnel all user requests to the Internet and fans responses back out to the appropriate users. Proxy servers also may cache Web pages, so that the next request can be obtained locally.

In this example, proxy server 404 may be located on a server, such as data processing system 200 in FIG. 2. In response to receiving this request, proxy server 404 forwards the request to the appropriate Web server, which is Web server 402 in this example. Web server 402 returns a Web page to proxy server 404. After receiving the Web page, proxy server 404 sends the Web page or the URL for the Web page to search engine 406. A search engine is software that searches for data based on some criteria. Search engine 406, proxy server 404, and Web server 402 may or may not be located at the same computer or server cluster. Search engine 406 may be a general purpose engine or a customized search engine having prior knowledge about the document. If the URL is received, search engine 406 retrieves the Web page from Web server 402. Search engine 406 performs a search using search engine database 408 as part of the process of analyzing the Web page. Search engine database 408 in addition to databases normally found in association with search engine may include additional resources, such as a dictionary or a thesaurus.

Existing search engines already include a capability to classify Web pages by key words. In the depicted examples, search engine 406 is modified to identify key words in response to receiving the Web page. This modification includes providing an appropriate key word by a reverse lookup in search engine database 408. The search engine may use the heuristics described below to determine a set of key words. For example, the search engine may parse a Web page and generate a count of how many times a word has been used in the document. While using this approach, the search engines may omit common words such as is, a, the etc. Alternatively, the search engine may scan the paragraph and subparagraph headings to pick out the key words. Another approach used by the search engine may be to parse the underlying HTML tags and pick out those words that are in italics, bold type etc. If the search engine is domain specific and knows that document is in a broad area, such as thermodynamics, the search engine may maintain an index of frequently used keywords and try to see if any words in the document are one of the indexed words.

This approach is especially suitable since the search space is significantly narrowed for the modified search engine. Alternatively, the modified search engine may use portals such as yahoo.com, which are classified by humans, and search the web page for major and minor classifications. Finally, another well known mechanism is used in case based reasoning as used in artificial intelligence (AI) in which a new document is compared to already known (possibly indexed) documents for closeness and the keywords may be generated based on that comparison.

As mentioned with respect to the present invention, a dictionary and a thesaurus may be used as additional tools by the search engine to look for keywords in a Web page. Instead of looking for a word, the search engine could use the synonyms for the word. Further, the search engine may generate keywords by using more than one method in parallel using multiple threads.

A set of key words are identified from the analysis of the document by search engine 406. This key word list is returned to proxy server 404. Proxy server 404 sends the Web page and the key word list to Home Page Reader 406. In this example, proxy server 404 modifies the Web page to include the key word list at the beginning or the top of the Web page. The Web page and the key word list may be sent separate, rather than as a modified Web page. Home Page Reader 406 then presents the key word list prior to presenting other portions of the Web page. Although this modified Web page is presented in a manner other than visually by Home Page Reader 406, this Web page also may be displayed depending on the implementation.

In this manner, an entire document is analyzed with search engine 406 picking out one or more key words that may be located in the middle of a Web page or a paragraph. This analysis and presentation of key words improves accessibility of a visually impaired user to content on the Web. Proxy server 404 is used to avoid display of an unmodified page. Proxy server 404 may be placed in a number of locations and may be located at the client.

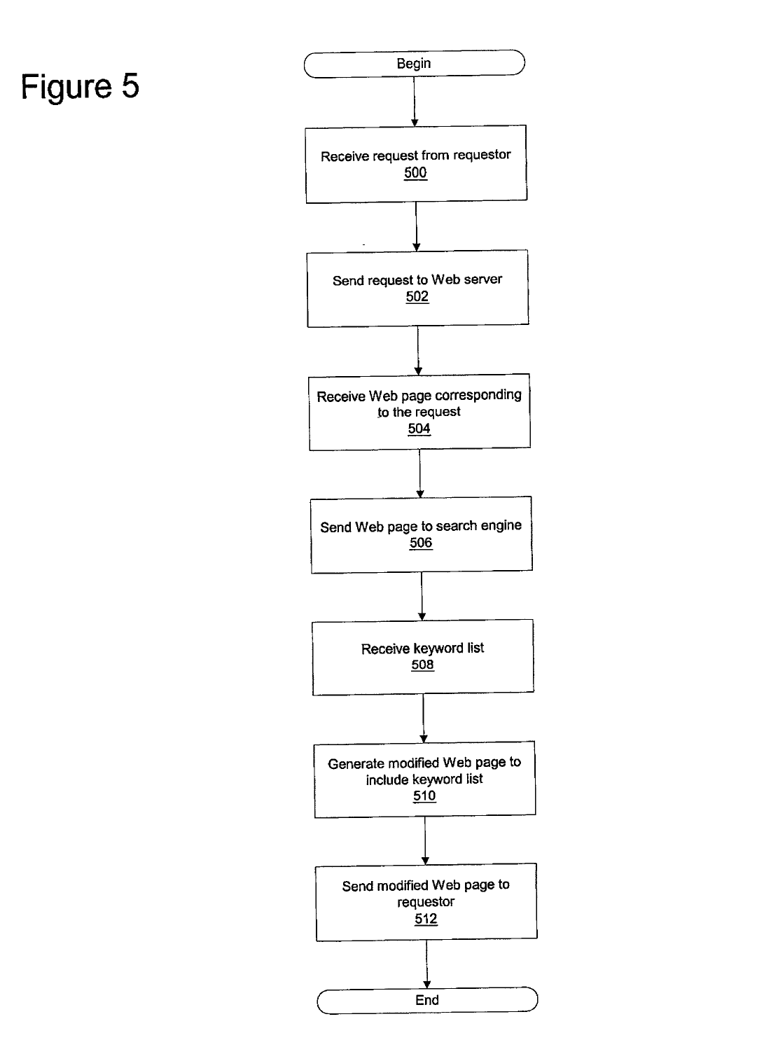

Turning next to FIG. 5, a flowchart of a process used for handling a request for a Web page from a user at a browser is depicted in accordance with a preferred embodiment of the present invention. The process illustrated in FIG. 5 may be implemented in a talking Web browser, such as Home Page Reader 406 in FIG. 4.

The process begins by receiving a request from requester (step 500). This request takes the form of a URL in these examples. Next, the request is sent to a Web server (step 502). A Web page corresponding to the request is received from the Web server (step 504). Then, the Web page is sent to a search engine (step 506). In return, a keyword list is received from the search engine (step 508). Next, a modified Web page is generated to include the keyword list (step 510). In the depicted example, the key word list is placed at the top of the Web page. Then, the modified Web page is sent to the requestor (step 512) with the process terminating thereafter.

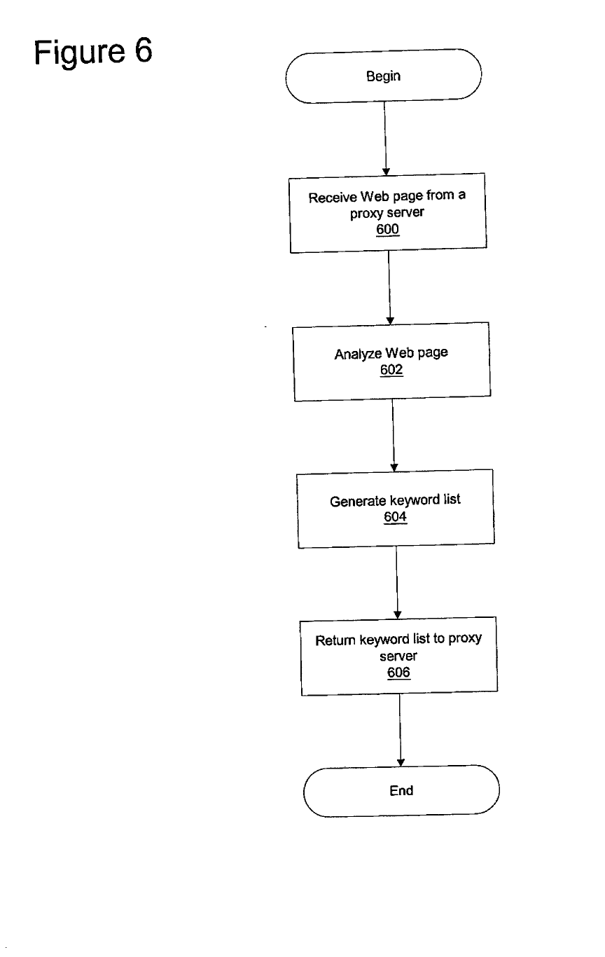

Turning next to FIG. 6, a flowchart of a process used for generating a key word list is depicted in accordance with a preferred embodiment of the present invention. The process illustrated in FIG. 6 may be implemented in a search engine, such a search engine 406 in FIG. 4.

The process begins by receiving a Web page from a proxy server (step 600). Next, the Web page is analyzed (step 602). This analysis includes searching a database and possibly using other resources, such as a dictionary or a thesaurus. A keyword list is generated (step 604). Then, the keyword list is returned to the proxy server (step 606) with the process terminating thereafter.

Thus, the present invention provides an improved method, apparatus, and computer implemented instructions for providing a list of key words for a Web page used for identifying content in the Web page. The mechanism of the present invention performs what is essentially a reverse lookup of key words in a search engine database and modifies a Web page to include the key words at the beginning or at the top of the Web page. This mechanism does not require additional load or traffic on a Web server because only a single request is sent to the Web server. Further, the proxy server is the only component that needs to be configured to contact a search engine. As a result, this mechanism is transparent to Web servers.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. Although the depicted examples present information audibly, other non-visual forms of presentation may be employed, such as generating dots in a Braille format. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for processing a request for a Web page, the method comprising:
responsive to receiving a request from a client data processing system for the Web page, retrieving the Web page from a Web server;
initiating an analysis of the Web page, wherein the analysis generates a list of key words from the Web page; and
sending the Web page and the list of key words to the client data processing system.

2. The method of claim 1, wherein the initiating step comprises:
sending the Web page to a search engine; and
receiving the list of key words from the search engine.

3. The method of claim 1, wherein the request includes a universal resource locator pointing to the Web page and wherein the initiating step comprises:
sending the universal resource locator to a search engine; and
receiving the list of key words from the search engine.

4. The method of claim 1, wherein the sending step comprises:
modifying the Web page to include the list of key words to form a modified Web page; and
sending the modified Web page to the client data processing system.

5. The method of claim 4, wherein the modified Web page is sent to a talking Web browser on the client data processing system.

6. The method of claim 1, wherein the retrieving, initiating, and sending steps are performed by a proxy server on the data processing system.

7. The method of claim 6, wherein the Web server is located on the data processing system.

8. The method of claim 1, wherein the Web server is located on a remote data processing system.

9. The method of claim 1, wherein the search engine is located on the data processing system.

10. A system for retrieving a Web pages, the system comprising:
a Web server, wherein the Web server is a repository for a plurality of Web pages;
a search engine, wherein the search engine identifies key words in a Web page; and
a proxy server, wherein the proxy server sends a universal resource locator to the Web server in response to receiving the universal resource locator from a client, receives a Web page from the plurality of Web pages, initiates an analysis of the Web page to generate a list of key words, and sends the Web page and the key words to the client.

11. A data processing system comprising:
a bus system;
a communications unit connected to the bus, wherein data is sent and received using the communications unit;
a memory connected to the bus system, wherein a set of instructions are located in the memory; and
a processor unit connected to the bus system, wherein the processor unit executes the set of instructions to retrieve a Web page from a Web server in response to receiving a request from client data processing system for the Web page; initiate an analysis of the Web page in which the analysis generates a list of key words from the Web page; and send the Web page and the list of key words to the client data processing system.

12. The data processing system of claim 11, wherein the bus system includes a primary bus and a secondary bus.

13. The data processing system of claim 11, wherein the processor unit includes a single processor.

14. The data processing system of claim 11, wherein the processor unit includes a plurality of processors.

15. The data processing system claim 11, wherein the communications unit is an Ethernet adapter.

16. A data processing system for processing a request for a Web page, the data processing system comprising:
retrieving means, responsive to receiving a request from client data processing system for the Web page, for retrieving the Web page from a Web server;
initiating means for initiating an analysis of the Web page, wherein the analysis generates a list of key words from the Web page; and
sending means for sending the Web page and the list of key words to the client data processing system.

17. The data processing system of claim 16, wherein the initiating means comprises:
first means for sending the Web page to a search engine; and
second means for receiving the list of key words from the search engine.

18. The data processing system of claim 16, wherein the request includes a universal resource locator pointing to the Web page and wherein the initiating means comprises:
first means for sending the universal resource locator to a search engine; and
second means for receiving the list of key words from the search engine.

19. The data processing system of claim 16, wherein the sending means comprises:
first means for modifying the Web page to include the list of key words to form a modified Web page; and
second means for sending the modified Web page to the client data processing system.

20. The data processing system of claim 19, wherein the modified Web page is sent to a talking Web browser on the client data processing system.

21. The data processing system of claim 16, wherein the retrieving means, initiating means, and sending means are located on a proxy server on the data processing system.

22. The data processing system of claim 21, wherein the Web server is located on the data processing system.

23. The data processing system of claim 16, wherein the Web server is located on a remote data processing system.

24. The data processing system of claim 16, wherein the search engine is located on the data processing system.

25. A computer program product in a computer readable medium for processing a request for a Web page in a data processing system, the computer program product comprising:
first instructions, responsive to receiving a request from client data processing system for the Web page, for retrieving the Web page from a Web server;
second instructions for initiating an analysis of the Web page, wherein the analysis generates a list of key words from the Web page; and
third instructions for sending the Web page and the list of key words to the client data processing system.

26. The computer program product of claim 25, wherein the second instructions comprises:
first sub-instructions for sending the Web page to a search engine; and
second sub-instructions for receiving the list of key words from the search engine.

27. The computer program product of claim 25, wherein the request includes a universal resource locator pointing to the Web page and wherein the second instructions comprises:
first sub-instructions for sending the universal resource locator to a search engine; and
second sub-instructions for receiving the list of key words from the search engine.

28. The computer program product of claim 25, wherein the third instructions step comprises:
first sub-instructions for modifying the Web page to include the list of key words to form a modified Web page; and
second sub-instructions for sending the modified Web page to the client data processing system.
